(19) United States
(12) Patent Application Publication
(10) Pub. No.: US 2019/0001767 A1
(43) Pub. Date: Jan. 3, 2019

(54) Air Maintenance System

(71) Applicant: The Goodyear Tire & Rubber Company, Akron, OH (US)

(72) Inventors: Jeffrey Silver TAGGART, Cleveland Heights, OH (US); Shawn William DELLINGER, University Heights, OH (US); Cheng-Hsiung LIN, Hudson, OH (US); Norman David ANDERSON, Hartville, OH (US)

(21) Appl. No.: 16/023,223

(22) Filed: Jun. 29, 2018

Related U.S. Application Data
(60) Provisional application No. 62/527,911, filed on Jun. 30, 2017.

(51) Int. Cl. B60C 23/12

(52) U.S. Cl. CPC B60C 23/12

(57) ABSTRACT

An air maintenance system for use with a pneumatic tire is described. The air maintenance system includes a pumping mechanism that is preferably mounted on the interior surface of a wheel rim to keep the pneumatic tire from becoming underinflated. The pumping mechanism includes at least one dual chamber pump, preferably at least two dual chamber pumps configured in series. More preferably, the dual chamber pumps are driven by an external mass that moves as the tire rotates. The tire's rotational energy operates the pump to ensure the tire cavity is maintained at the desired pressure level. An optional control valve shuts off airflow to the pumping mechanism when the tire cavity pressure is at the desired level.

### FIELD OF THE INVENTION

The present invention relates generally to an air maintenance system for use with a tire and, more specifically, to an air maintenance pumping assembly.

### BACKGROUND OF THE INVENTION

Normal air diffusion reduces tire pressure over time. The natural state of tires is under inflated. Accordingly, drivers must repeatedly act to maintain tire pressures or they will see reduced fuel economy, tire life and reduced vehicle braking and handling performance. Tire Pressure Monitoring Systems have been proposed to warn drivers when tire pressure is significantly low. Such systems, however, remain dependent upon the driver taking remedial action when warned to re-inflate a tire to recommended pressure. It is a desirable, therefore, to incorporate an air maintenance feature within a tire that will maintain air pressure within the tire in order to compensate for any reduction in tire pressure over time without the need for driver intervention.

### Definitions

“Aspect ratio” of the tire means the ratio of its section height (SH) to its section width (SW) multiplied by 100 percent for expression as a percentage.

“Asymmetric tread” means a tread that has a tread pattern not symmetrical about the center plane or equatorial plane EP of the tire.

“Axial” and “axially” means lines or directions that are parallel to the axis of rotation of the tire.

“Chafer” is a narrow strip of material placed around the outside of a tire bead to protect the cord plies from wearing and cutting against the rim and distribute the flexing above the rim.

“Circumferential” means lines or directions extending along the perimeter of the surface of the annular tread perpendicular to the axial direction.

“Equatorial Centerplane (CP)” means the plane perpendicular to the tire's axis of rotation and passing through the center of the tread.

“Footprint” means the contact patch or area of contact of the tire tread with a flat surface at zero speed and under normal load and pressure.

“Groove” means an elongated void area in a tire dimensioned and configured in section for receipt of an air tube therein.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint as measured under normal load and tire inflation, the lines being parallel to the equatorial centerplane.

“Net contact area” means the total area of ground contacting tread elements between the lateral edges around the entire circumference of the tread divided by the gross area of the entire tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Sipe” means small slots molded into the tread elements of the tire that subdivide the tread surface and improve traction, sipes are generally narrow in width and close in the tires footprint as opposed to grooves that remain open in the tire's footprint.

“Tread element” or “traction element” means a rib or a block element defined by having a shape adjacent grooves.

“Tread Arc Width” means the arc length of the tread as measured between the lateral edges of the tread.

### BRIEF DESCRIPTION OF THE DRAWINGS

The invention will be described by way of example and with reference to the accompanying drawings in which:

FIGS. 1A and 1B illustrate a front, and perspective view of a pump system of the present invention mounted on the inner hub of a wheel.

FIG. 2A illustrates a close-up perspective view of a pump system of the present invention mounted on a wheel.

FIG. 2B illustrates the pump system of FIG. 2A, shown with the wheel removed.

FIG. 3 illustrates a close-up view of an inlet control valve, a pump and an actuation system of the present invention.

FIG. 4 illustrates a modified valve stem of the present invention.

FIG. 5 illustrates a cross-sectional view of the modified valve stem of FIG. 4.

FIG. 6 illustrates an exploded view of the modified valve stem of FIG. 4.

FIG. 7 illustrates a schematic of a pump and integrated valve assembly and flow block of the present invention.

FIGS. 8 and 9 illustrate cross-sectional perspective, and front views of the pump and integrated valve assembly of FIG. 7.

FIG. 10 illustrates an exploded view of the flow block assembly.

FIG. 11 illustrates a cross-sectional view of the inlet control valve.

FIG. 12 is a schematic of how two double chamber pumps are connected in series with check valves between the pump chambers.

### DETAILED DESCRIPTION OF AN EXAMPLE OF THE PRESENT INVENTION

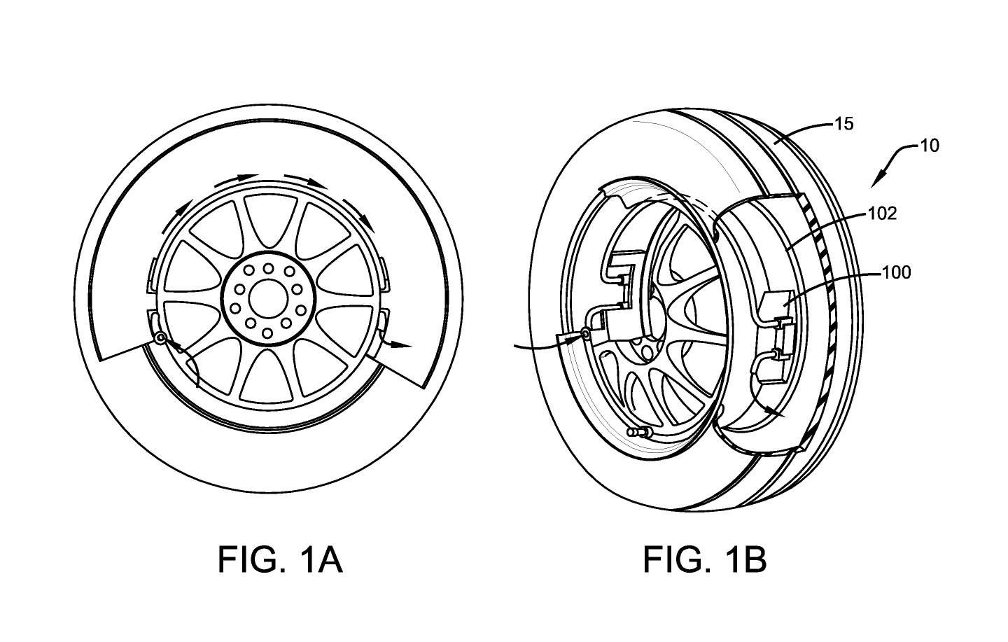

The present invention is directed to an air maintenance system 10, and is shown in FIGS. 1 through 12. The air maintenance system 10 includes one or more pump assemblies 100 that may be used to pump air into a tire cavity. The tire is of conventional construction, having a pair of sidewalls extending from opposite bead areas to a crown or tire bead region. The tire mounts in conventional fashion to a wheel 200 having a pair of rim mounting surfaces 204. The wheel includes an inner rim surface 206 located between the rim mounting surfaces 204 for mounting the air maintenance system 10. The tire 15 and rim inner surface 206 enclose a tire cavity 102.

The pump assembly 100 of the present invention is preferably mounted in the tire cavity to the wheel rim inner surface 206 of the wheel 200. The rim surface may preferably comprise a groove 203 for mounting the pump assembly 100. The pump assembly may alternatively be located on the outer wheel surface 205, opposite the inner surface 206, so that the pump assembly is located on the wheel, and outside of the tire cavity.

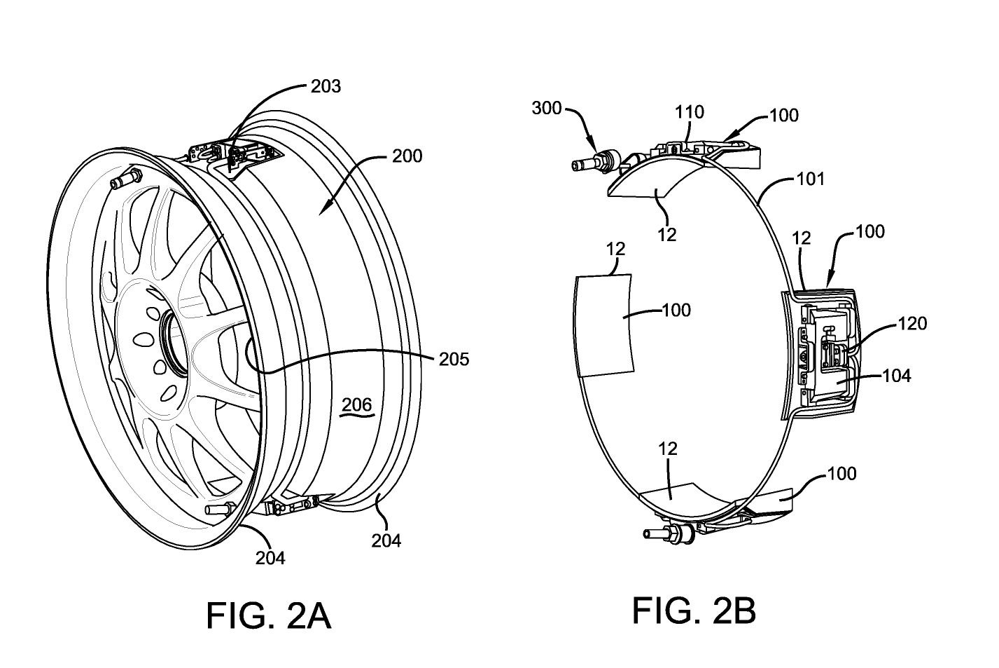

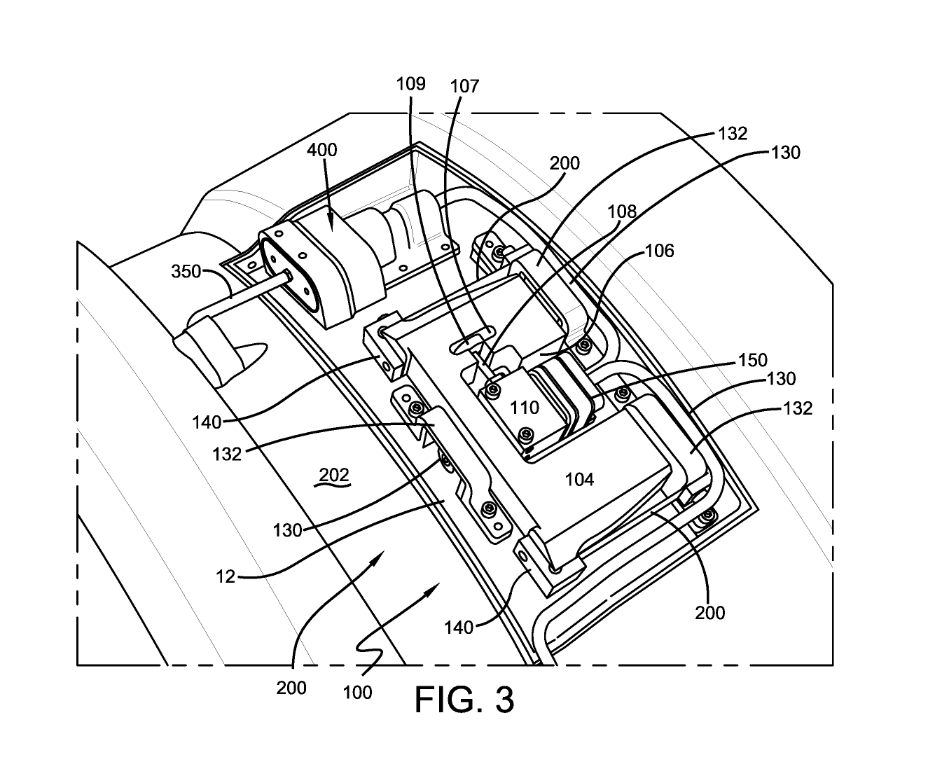

The pump assembly 100 as shown in FIGS. 2-3, includes an external sliding mass 104. The sliding mass 104 is preferably mounted upon a low friction plate 12. The low friction plate 12 is mounted on the wheel inner surface 206 to provide a low friction sliding surface. As shown in FIG. 2B, the low friction plate 12 is preferably curved to match the curvature of the inner rim surface. The external sliding mass 104 as shown has the general shape of a C, with a pump 110 being located in a cutout portion 106 of the C. The pump 110 is stationary with respect to the sliding external mass. The external sliding mass has a slot 107 for receiving a distal end 109 of a piston 108. The as the external mass slides, the piston is actuated inside the pump chamber 111. More preferably, the sliding mass 104 is mounted upon bearing blocks 140 to reduce the friction of the sliding mass 104. When the sliding mass slides, the piston 108 slides in and out of the pump chamber, resulting in compression of the air inside the pump chamber.

As shown in FIG. 3, each external sliding mass 104 preferably includes at least one guide member 130 that is contained within guide slots 132. More preferably, there are at least two guide members 130 located on opposite sides of the external sliding mass 104. Most preferably, there are at least three guide members contained within a respective guide slots 132.

To facilitate motion of the external mass, a leaf spring member 200 is preferably mounted to the external mass. The leaf spring 200 has a first end mounted to the external mass and a second end mounted to a fixed point such as the outer surface of the guide slots 132. Preferably, there are at least two leaf spring members.

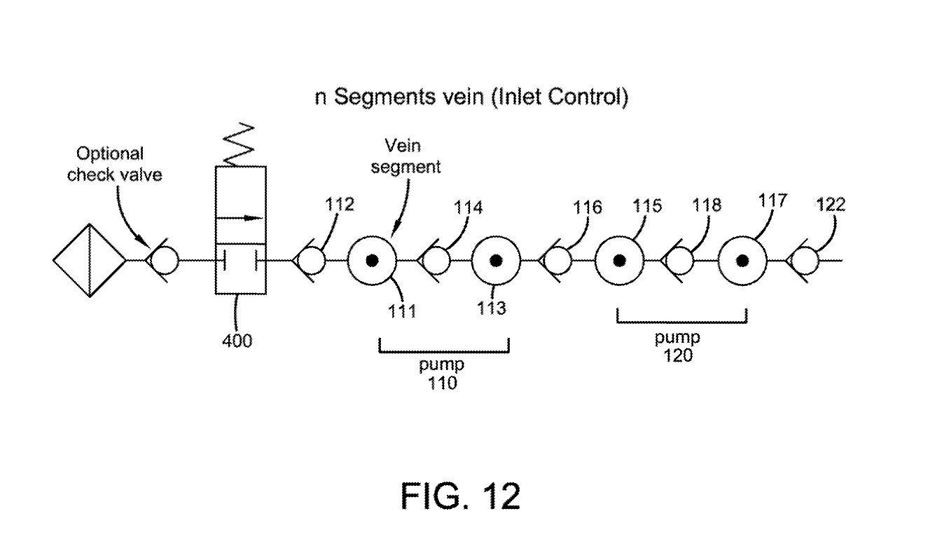

Preferably, each pump 110 is a double acting pump—i.e., has two chambers. More preferably, the pump chambers are connected in series. Thus first pump 110 has a first pump chamber 111 and a second pump chamber 113. The piston forms a seal to allow for the two internal chambers of each pump. FIG. 12 illustrates that each pump chamber 111,113,115,117 is connected in series with an adjacent pump chamber for the pump amplification effect. Preferably, at least one check valve 112,114,116,118,122 is located between a respective pump chamber to prevent backflow. As shown in FIG. 12, the direction of flow is shown from right to left. Preferably, there are at least two pump assemblies 100 connected in series by tube 101.

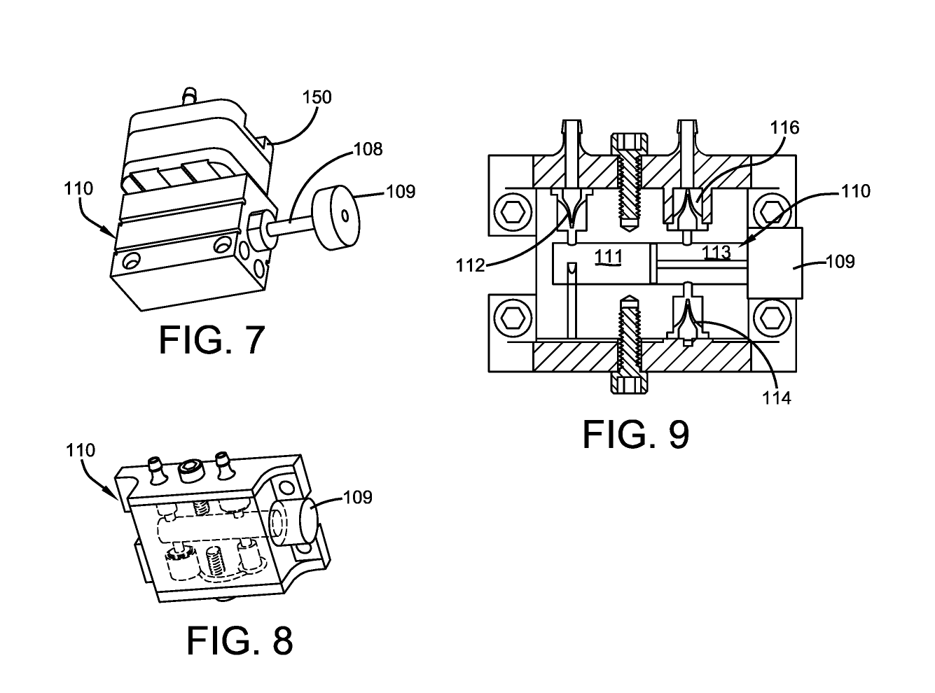

As shown in FIGS. 7-9, each pump assembly 110 has a piston 108 that reciprocates in the one or more pump chambers 111,113. As best shown in FIG. 9, the check valves and flow pathways that interconnect the pump chambers are preferably integrated into the pump assembly 110.

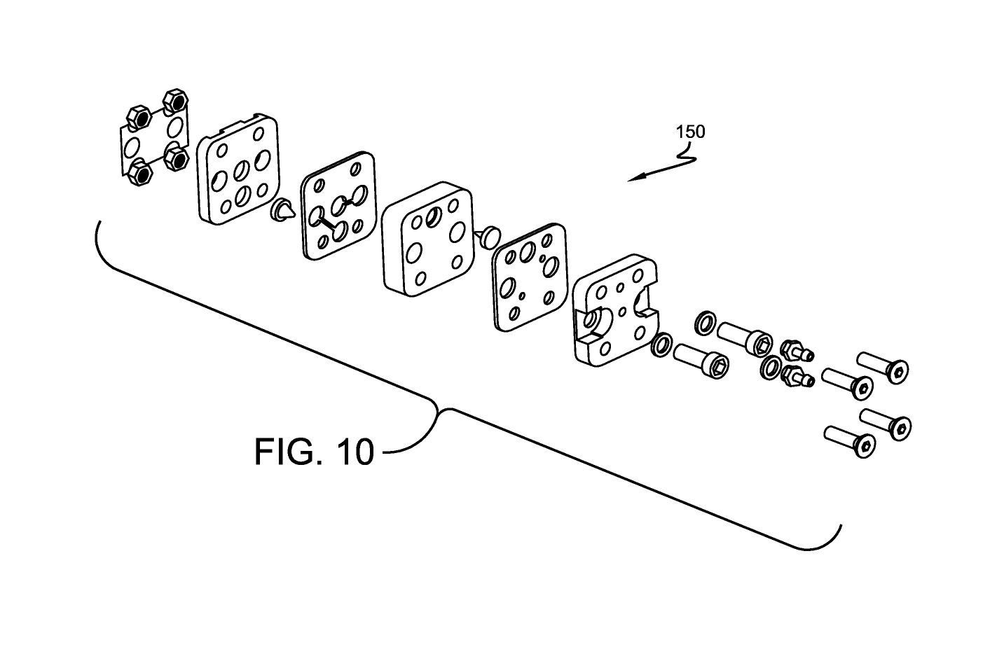

FIG. 10 illustrates an optional flow control block assembly 150 that is connected to the pump assembly 110. The flow control block assembly includes two additional check valves to prevent backflow of the air being supplied to the pump assembly 110.

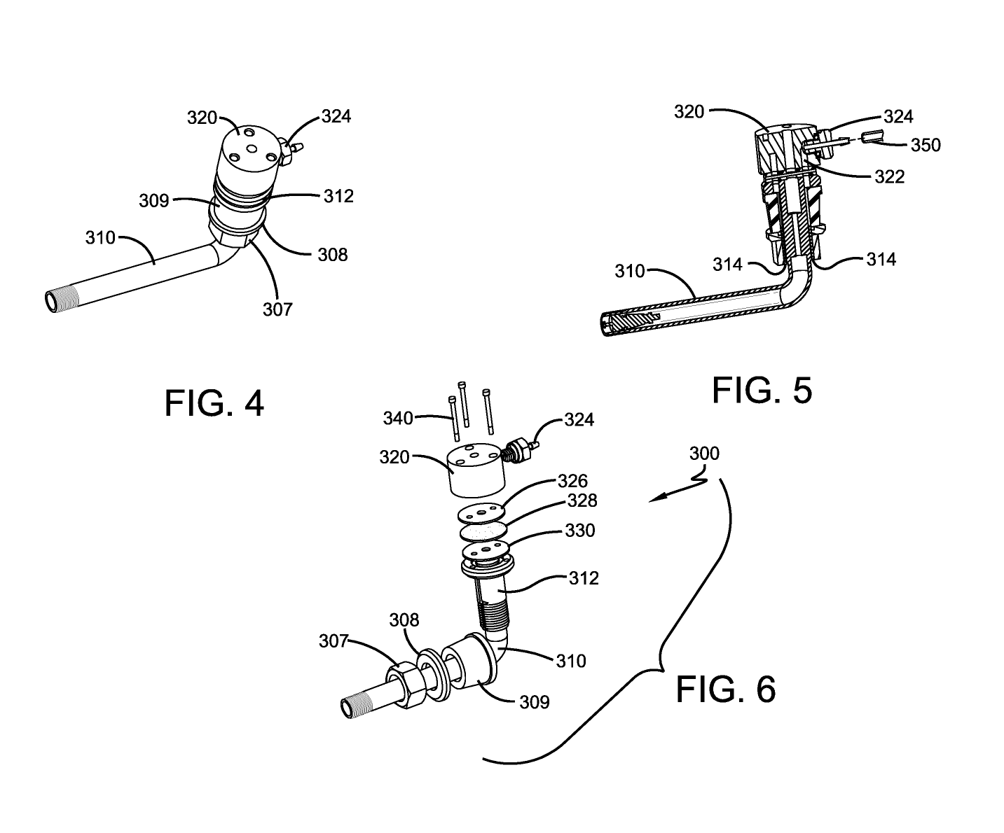

Airflow is introduced into the pump assembly 100 via a modified valve stem assembly 300. The modified valve stem assembly 300 is shown in FIGS. 4-6. The modified valve stem assembly 300 provides air from the outside to be pumped into the pump assemblies 100. The modified valve stem assembly allows the standard valve stem function to allow air to be filled in the tire the conventional way and also allow for the tire pressure to be checked in the conventional way. The valve stem body 312 has been modified to include one or more passageways 314 that communicates outside air through the body 312 of the valve stem and into flow channels 322 of a double channel connector 320. As the outside air travels through the passageways 314, it is filtered by filter 328. A first and second gasket 326,330 prevents leakage. The double channel connector 320 has an adaptor 324 for connecting to an air inlet tube 350. The air inlet tube 350 is preferably connected to an inlet control valve 400, and supplies outside air to the pump system via the inlet control valve.

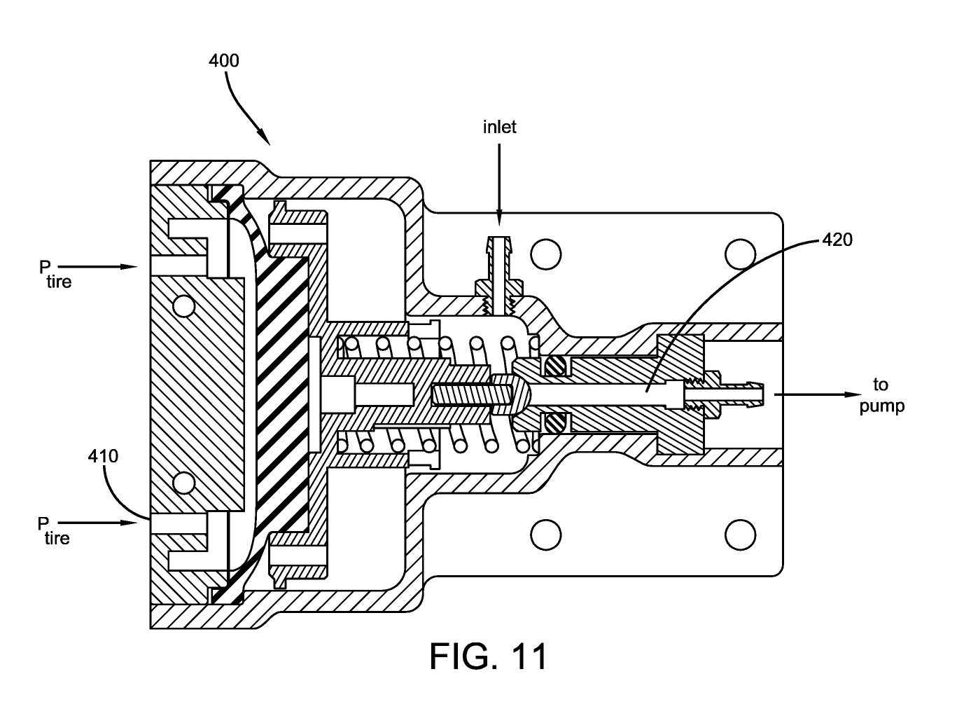

The inlet control valve 400 is shown in FIG. 11 and FIG. 3. The inlet control valve 400 senses the tire cavity pressure through ports 410, and if the tire cavity pressure is below the threshold level, the inlet control valve allows the air to pass from the air inlet tube 350 through the interior channel 420 and then into the pump assemblies 100. If the tire pressure is above the threshold, the inlet control valve remains closed, as shown in FIG. 11.

Preferably, there are at least two pump assemblies 100 are connected together so that each pump chamber is connected in series with another pump chamber, as shown in FIG. 13. Due to an amplification effect, the compression of the pump assembly may be defined as:

R=(r)²ⁿ

where

R: system compression ratio

r: single chamber compression ratio

n: number of pump in the system

Thus, a high compression ratio for each pump chamber is not necessary to achieve a high compression ratio (e.g., low force and/or deformation may produce high compression).

The pump assembly of the present invention is bi-directional. Hence, the rotation direction or installation direction will not have significant effect on pumping performance.

The pump driving mechanism of the present invention is based on gravitation change of the external mass during tire rotation. As the wheel is rotated, the sliding action of each external mass causes actuation of each piston pump due to the coupling of the external mass to the piston. Higher vehicle speed provides higher pumping frequency. The pumping action only depends on the external mass, and will not be affected by tire load or any other external conditions.

While certain representative examples and details have been shown for the purpose of illustrating the present invention, it will be apparent to those skilled in this art that various changes and modifications may be made therein without departing from the spirit or scope of the present invention.

What is claimed:

1. A pneumatic tire and rim assembly comprising:
a pump assembly mounted to a wheel rim of the rim assembly, said pump assembly having a piston mounted in a chamber, wherein an external sliding mass is connected to a distal end of the piston, wherein said external mass operates the pump assembly during rotation of the tire.

2. The pneumatic tire and rim assembly of claim 1 wherein said pump is a double acting pump having a first and second chamber.

3. The pneumatic tire and rim assembly of claim 1 further including a plurality of check valves for maintaining air flow in the pumps in a single direction.

4. The pneumatic tire and rim assembly of claim 2 wherein the first and second pump chambers are connected in series.

5. The pneumatic tire and rim assembly of claim 4 wherein a check valve is provided between the first and second pump chambers.

7. The pneumatic tire and rim assembly of claim 1 further including an inlet control valve for controlling inlet air into at least one of the pump assemblies.

8. The pneumatic tire and rim assembly of claim 1 wherein the external sliding mass is connected to a leaf spring.
